(19) United States
(12) Patent Application Publication
(10) Pub. No.: US 2010/0017739 A1
(43) Pub. Date: Jan. 21, 2010

(54) Method for Defining a Graphic Control for Use in a Building Automation System Control Environment

(75) Inventor: James K. Han, Long Grove, IL (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Building Technologies, Inc.

(21) Appl. No.: 12/504,637

(22) Filed: Jul. 16, 2009

Related U.S. Application Data
(60) Provisional application No. 61/081,526, filed on Jul. 17, 2008.

(51) Int. Cl. G06F 3/048; G06F 15/16

(52) U.S. Cl. 715/772; 709/203; 715/234

(57) ABSTRACT

A method of displaying a value in a building control system includes a step of retrieving a graphic object template defined as a markup language string. The graphic object template includes a plurality of primitive elements, each of the plurality of primitive elements defined as a portion of the markup language string. At least some of the primitive elements have a parameter configurable to be dependent upon the value of the data point. For example, the primitive elements support properties (e.g. layout, colors, visibility, etc.), which can be configured to be dependent upon the value of a data point's property (e.g. present value, alarm state, etc.). The method also includes creating an instance of a graphic object template by binding a data point to the graphic object template. The method further includes obtaining a change of value for the data point, and updating the display to change the appearance of the first graphic primitive element based on the evaluation.

This application claims the benefit of U.S. Provisional Patent Application Ser. No. 61/081,526, filed Jul. 17, 2008, which is incorporated herein by reference.

### FIELD OF THE INVENTION

The present invention relates to the monitoring and control of elements of a building system, and more specifically, to graphical interfaces used for such monitoring and controlling.

### BACKGROUND OF THE INVENTION

Building control systems encompass a wide variety of systems that aid in the monitoring and control of various aspects of building operation. Building control systems include security systems, fire safety systems, lighting systems, and heating, ventilation, and air conditioning (“HVAC”) systems. In large commercial and industrial facilities, such systems have an extensive number of elements and are highly automated.

The elements of a building control systems are widely dispersed throughout a facility. For example, an HVAC system includes temperature sensors and ventilation damper controls, as well as other elements that are located in virtually every area of a facility. Similarly, a security system may have intrusion detection, motion sensors and alarm actuators dispersed throughout an entire building or campus. Likewise, fire safety systems include smoke alarms and pull stations dispersed throughout the facility. To achieve efficient and effective building control system operation, there is a need to monitor the operation of, and often communicate with, the various dispersed elements of a building control system.

To this end, building control systems typically have one or more centralized control stations in which data from the system may be monitored, and in which various aspects of system operation may be controlled and/or monitored. A control station typically includes a computer having processing equipment, data storage equipment, and a user interface. To allow for monitoring and control of the dispersed control system elements, building control systems often employ multi-level communication networks to communicate operational and/or alarm information between operating elements, such as sensors and actuators, and the centralized control station.

Initially, control stations provided building control data in text format, which typically required intimate system knowledge to interpret and understand. As building control systems become more complex, it has become increasingly advantageous to present building system data in a more intuitive manner. Thus, control stations of building control systems now generally employ graphical user interfaces that combine text information with representative graphics to illustrate the context of the system data being displayed.

An example of the use of representative graphics may be the use of a thermometer shaped graphic to represent a temperature reading, as opposed to a simple one line text value. Similarly, the alarm status for a floor of building may be represented on a graphical display of the building floor plan, as opposed to a simple text list of alarm locations.

One example of a building control system control station that employs a graphical user interface in the control station is the Apogee Insight™ Workstation, available from Siemens Building Technologies, Inc. of Buffalo Grove, Ill., which may be used with the model Apogee™ building control system, also available from Siemens Building Technologies, Inc. In this system, several control stations, connected via an Ethernet or another type of network may be distributed throughout one or more building locations, each having the ability to monitor and control system operation. As a consequence, different people in different locations of the facility may monitor and control building operations.

While the use of multiple networked control stations provides a high level of convenience and efficiency, there has been a growing need to be able to monitor and/or control systems from offsite locations. Various systems have been proposed to provide Internet access to building control system data. In such systems, an on-site workstation or other computer acts as a server to remote clients. U.S. Pat. No. 6,157,943 to Meyer proposes an example of such a system, as does U.S. Patent Publication No. 20040049577, both of which are incorporated herein by reference.

In the past, graphics employed in the user interfaces were custom configured for each application. While code could be reused, the reused code had limited flexibility, and modification of a graphic could involve significant software modification. In some cases, the software allowed for an application engineer to slightly modify a few parameters. However, the limited ability to modify a few display options was hard-coded into the graphics program.

### SUMMARY OF THE INVENTION

At least some embodiments of the present invention allow for the provision of a graphical interface that can be easily customized with no revision of software code.

A first embodiment is a method of displaying a value in a building control system that includes a step of retrieving a graphic object template defined as a markup language string. The graphic object template includes a plurality of primitive elements, each of the plurality of primitive elements defined as a portion of the markup language string. At least some of the primitive elements have a parameter configurable to be dependent upon the value of the data point. For example, the primitive elements support properties (e.g. layout, colors, visibility, etc.), which can be configured to be dependent upon the value of a data point's property (e.g. present value, alarm state, etc.). The method also includes creating an instance of a graphic object template by binding a data point to the graphic object template. The method further includes obtaining a change of value for the data point, and updating the display to change the appearance of the first graphic primitive element based on the evaluation.

The definition of the template and its primitive elements in markup language presents a structure that allows for granular modifications of graphical objects, thereby allowing customization without knowledge of software code.

The above-described features and advantages, as well as others, will become more readily apparent to those of ordinary skill in the art by reference to the following detailed description and accompanying drawings.

### BRIEF DESCRIPTION OF THE DRAWINGS

FIG. 1 shows a diagram of a hardware and software architecture in which an exemplary embodiment of the present invention may be implemented;

FIG. 2 shows an exemplary set of steps that may be used to create a graphic object template in accordance with an embodiment of the invention;

FIG. 3 shows examples of rendered graphic objects that may be generated in accordance with embodiments of the invention;

FIG. 4 shows an example of a graphic page structure and a graphic object template structure in accordance with an embodiment of the invention;

FIG. 5 shows an exemplary set of steps performed by the elements of FIG. 1.

### DETAILED DESCRIPTION

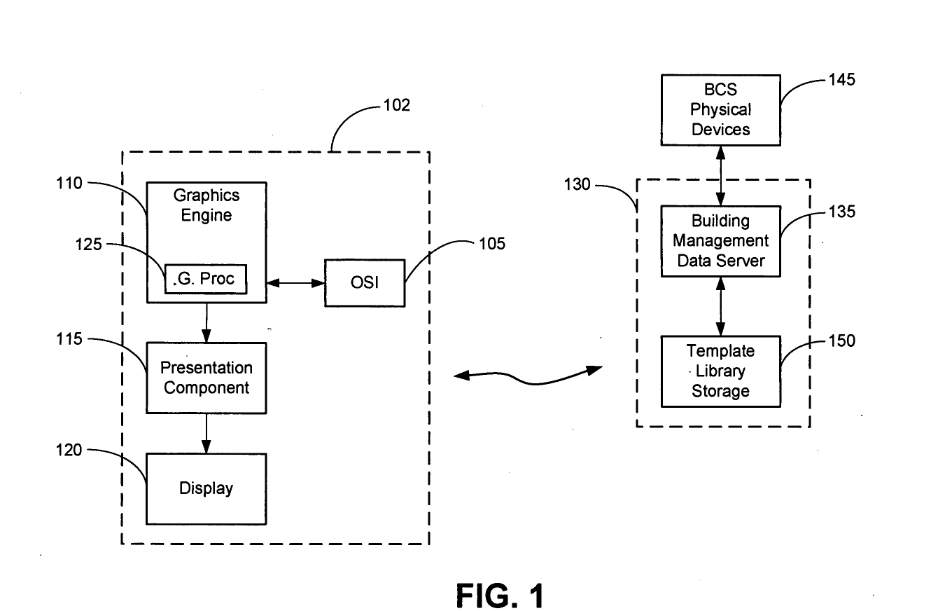

FIG. 1 shows a diagram of a hardware and software architecture on which an exemplary embodiment of the present invention may be implemented. The architecture includes, in general, a client computer 102 and one or more server computers 130. The client computer 102 has a processing circuit, not shown, that executes programming instructions stored in memory, also not shown, to carry out the operations ascribed to the client computer 102. The client computer 102 may be a “thin” client or a thick client. A thin client, which is typically a web client, is client software in a client-server architecture networks which depends primarily on the central server for processing activities, and mainly focuses on conveying input and output between the user and the remote server via a HTTP communication protocol. By contrast, a thick client, which is typically installed, does as much processing as possible and passes only data for communications and storage to the server via a TCP/IP communication protocol.

The one or more server computers 130 include one or more processing circuits, not shown, that collectively execute programming instructions to carry out the operations ascribed herein to various server computers 130. As will be discussed below, the server computers 130 operate to provide services to the client computer 102, including building control management data access services, and object template library access services. These services may be provided by one or more physical computers, as would be known to one of ordinary skill in the art.

As shown in FIG. 1, the client computer 102 includes an operating system interface 105, a graphics engine 110, a presentation component 115, and a display device 120. The operating system interface 105 is a source of data, requests, and/or commands for the graphics engine 110. The operating system interface 105 is the interface through which applications executed on the client computer 102 interact with the graphics engine 110. By way of example, the operating system interface 105 may suitably be an interface provided by the WINDOWS Vista or XP Operating System available from Microsoft Corporation of Redmond, Wash.

The graphics engine 110 is a software component that allows for the viewing of, and in this embodiment, configuring of, runtime graphics. The graphics engine 110 includes a graphics processor 125 that serializes graphic data files for interaction with the presentation component 115. In general, the graphics processor 110 has the ability to convert graphics descriptions formed as XAML files into a format expected to by the presentation component 115. The structure of the XAML files is discussed further below in detail.

The presentation component 115 is a presentation format component that is capable of rendering graphics based on the serialized graphic data files received from the graphics engine. By way of example, the presentation component 115 may suitably be the Windows Presentation Foundation (“WPF”) component, including a Milcore component, available from Microsoft Corporation. The interfaces for rendering graphics in the WPF Milcore environment are known in the art.

The display 120 may by any suitable computer display device (and driver) that is configured to display graphics under the control of the presentation component 115.

The server computers 130 in the embodiment described herein include a building control management data server 135. It will be appreciated that various other services and clients may be incorporated. Such other services and clients have been omitted for clarity of exposition of the invention. The building control management data server 135 is one or more computer servers or other devices that communicate directly or indirectly with physical elements 145 of a building control system, such as sensors, actuators, controllers, and the like. Building control server arrangements are known in the art. In this embodiment, the building control management data server 135 is configured to obtain values from physical elements of the building control system, such as measurement (sensor) values, set points, alarms, and forth, and provide those values via an interface to the client, for example, to the client computer 102 via requests from the graphics engine 110, as will be discussed below.

The building server 135 has access to one or more memory storage devices 150 that store a set of library files containing a plurality of graphic template objects. The graphic template objects in this embodiment are stored as XAML text files, the text files describing the features of the template object in editable text format. The graphic template objects are composed of graphic primitive elements also represented in XAML text format. The format of the graphic template objects allows for ease of editing, thereby allowing custom-configured graphic representations to be developed without requiring development of new graphic software, as would have previously been required. Further detail on this feature is provided further below.

One of the functions of the elements of FIG. 1 is to provide a graphical user interface between a user and the physical elements 145 of the building control system. To this end, a logical connection is established between at least one of the server computers 130 and the client computer 102. The client computer 102 may suitably execute applications that host the graphics engine 110 that request displays via the OSI 105.

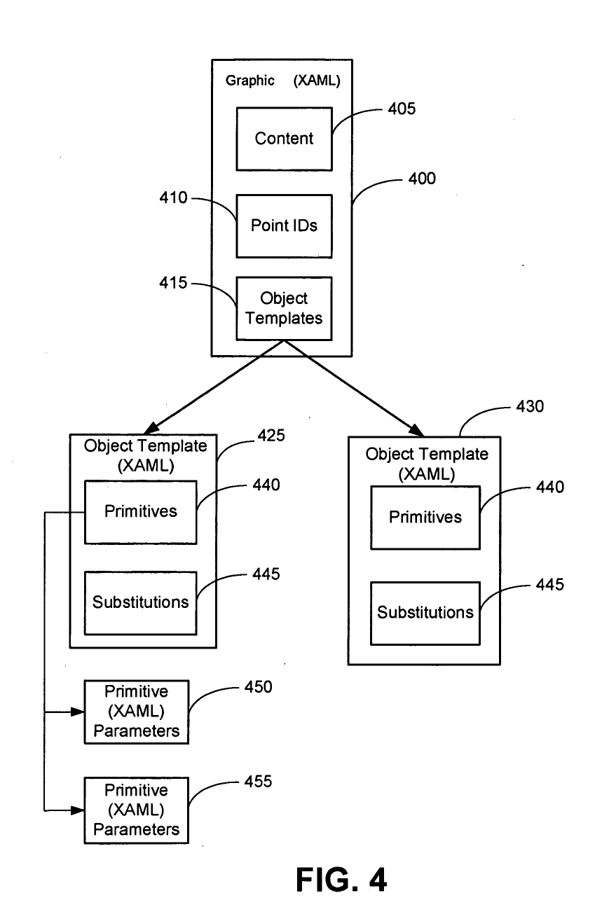

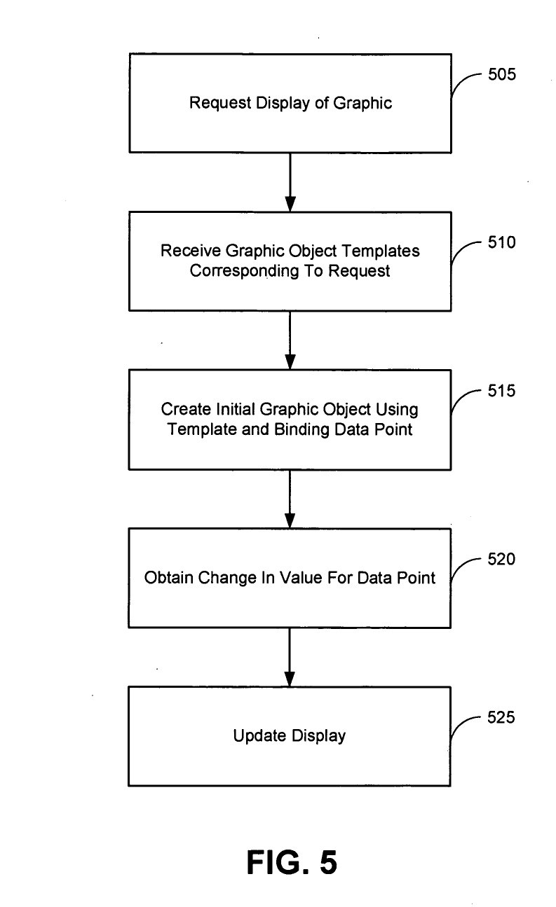

A typical graphic display scenario is described in connection with FIGS. 1 and 5. FIG. 5 shows the operations of the elements performed to display a requested graphic. As will be discussed below, in the embodiment described herein, the building control management data server 135 provides the client computer 102 with graphic pages for display, each graphic page possibly including one or more graphic object template instances, each graphic object template instance including one or more primitive elements. Data values from the physical devices can be reflected in the graphics. Further detail regarding this structure is provided below in connection with FIG. 4.

In a typical display scenario, a user at the client computer 102 will directly or indirectly request the display of a value of one of the physical devices 145 of the building control system. (Step 505). Such a request may identify a device (e.g. sensor, chiller, air-handling unit), a geographic location (e.g. room, floor, zone) or a specific quality (e.g. temperature, etc.). For example, the user may desire to see a specific zone temperature as measured by two temperature sensors.

The user's request is passed via the OSI 105 to the graphics engine 110. The graphics engine 110 passes the request for information to the building management data server 135. Each request from the user is associated at the client computer 102 with a particular “point ID” that is also known to the building system data server 135. The point ID is an identification string that uniquely identifies the elements, spaces or properties desired to be displayed. For example, a point ID may identify the specific zone temperature being requested.

The building management data server 135 identifies an appropriate graphic page relating to the requested point ID. To this end, the building management data server 135 preferably has (or can generate) a defined graphics page that corresponds to many or all point IDs that may be requested by the user. Each graphics page includes sufficient information for a graphic rendering of the information identified by the requested “point ID”, including representation of data from one or more physical devices 145 of the building control system.

Moreover, it will be appreciated that the graphic page corresponding to a point ID may include data values corresponding to other point IDs. For example, a graphic corresponding to a point ID for a zone of a building may suitably include identification of the point IDs for each temperature sensor in that zone, as well as point IDs for each ventilation dampers in the zone.

FIG. 4 shows an exemplary structure 400 of a graphic page, including its constituent structures. A graphics page structure 400 is preferably stored in an extensible mark-up language format such as XAML. The structure 400 includes content definitions 405 which may describe dimensions, background colors and other information regarding the graphic. The structure further includes an identification of point IDs 410 that are included in the graphic. As discussed above, for example, a zone graphic may include point IDs for temperature sensors and dampers associated with the room. Finally, the structure also includes object template identifiers 415. The object template identifiers 415 identify or list the graphic object templates that are to be instantiated to complete the rendering of the graphic page. The graphic object templates may include, for example, graphics for a thermometer bar (having animation or a variable quality indicating the actual temperature value), a depiction of a device (having a variable quality indication whether its operational state is “on” or “off”), or a simple graphic depiction of a damper device or other element.

The graphic object templates themselves are stored in the template library 150, so that they may be reused by various graphic pages. FIG. 4 further shows the structure of exemplary graphic object templates 425, 430 as they are stored in the template library 150. The graphic object templates 425, 430 are stored in XAML string format, similar to the graphic page structure 400. It will be noted that the XAML file of the graphics page structure 400 itself does not include the XAML file of the templates 425, 430, but rather only a reference to the templates 425 and 430.

Each of the graphic object templates 425, 430 includes one or more (and typically a plurality of) primitives 440, and often one or more substitutions 445. Substitutions 445 are mechanisms by which data values are moved into the template. Thus, for example, if a graphic may change its appearance to indicate a temperature level, a substitution for a specific temperature data point ID is provided in the graphic object template 425, 430. When the graphic object templates 425, 430 are eventually instantiated at runtime, then selected data values of the “substituted” point ID are “inputted” to the instantiated graphic object.

Each of the primitives 440 is a set of XAML text definitions identifying the characteristics or parameters of the corresponding primitive. For example, a “line” primitive may include length, location, and rotational angle parameters that must be defined, and a “rectangle” primitive may include length, width, location and rotational angle parameters that must be defined. According to one aspect of the invention, values of the parameters may be either static (as to define a permanent shape), or variable. Variable parameters (addressed via “substitutions”) are based on a data value for a point ID derived from one or more of the physical devices 145 element of the building control system.

For example, suppose one primitive 440 of the object template 425 is a rectangle having a length, width, rotational angle and position parameter. The user may define the length, width, and position parameter within the object template to be static, but to have the rotational angle dependent upon a data value obtained from a temperature sensor in the building control system. In such a case, when the graphic object template 425 is instantiated using the particular point ID of the temperature sensor, the rectangle primitive 440 will have a rotational angle that depends upon the sensed temperature. Such a primitive may be used to define a “tachometer” style graphical gauge, where the rectangular “needle” rotates through a scale indicating temperature. In another example, the same primitive may have a static rotational angle, but a length that is dependent upon the data value obtained from a temperature sensor. In such a case, when the graphic object template 425 is instantiated using the particular point ID of the temperature sensor, the rectangle primitive element will have a length that depends upon the sensed temperature. Such a primitive may be used to define a “thermometer” style graphical temperature gauge.

The parameters (static and otherwise) of the primitives are identified in markup string format, so that they are readily editable by those of ordinary skill in the art. Moreover, each of the object templates includes the markup string for all primitives identified therein. As a result, the object template for a complex figure that includes many primitives will have a longer XMAL string than would an object template with few primitives.

Nevertheless, it will be appreciated that the XAML files permit relatively easy reconfiguration or customization of an object template. In the past if the graphic rendering of a device was to be changed, for example, to include one or more additional features, then extensive knowledge of the graphic rendering code was required. In the embodiments described herein, the XAML file format of the object template allows for easy modification of existing templates to customize graphics for a particular user's needs.

Referring again to FIGS. 1 and 5, the building management data server 135 provides the retrieved graphic page to the graphics engine 110. The building management data server 135 may further provide the graphics engine 110 with the graphic object templates defined in the XAML string of the retrieved graphics page. (Step 510). To this end, the building management data server 135 may parse the graphics page, identify the included graphic object templates, and obtain the XAML strings of the included graphic object templates from the template library storage 150, and provide the XAML strings to the graphics engine 110. Alternatively, the graphics engine 110 may receive the graphics page, parse the graphics page, and then generate a request from the template library 150 (via a server) to retrieve and send any included graphic object templates.

In either event, the graphics engine 110 receives the XAML strings of the included graphic object templates as well as the XAML string of the graphic page itself. The graphic processor 125 then loads and renders the graphic XAML. Rendering the graphic XAML includes providing serialized graphical data from the graphic XAML string to the presentation component 115, obtaining data values generated by the building control system physical devices 145, and instantiating the graphic objects from the graphic object template XAML strings. Instantiating the graphic objects includes binding the data point IDs identified in the graphic page XAML string to the graphic objects defined by the graphic object template XAML strings. (Step 515).

To obtain the data values of the point IDs in the graphic XAML, the graphics processor 125 subscribes to the data point IDs listed in the graphic XAML. By “subscribing”, it is meant the that the graphics processor 125 requests a service from the building management data server 135 to provide data values for the point IDs listed in the graphic XAML. In this service, the building management data server 135 obtains the data value, which may suitably be a value generated by (or regarding) a physical device 145 of the building control system, and provides the data value to the graphics processor 125. The building management data server 135 further provides any changes in the data value (i.e. a temperature value that rises or falls, or a device state change from “on” to “off”) to the graphics processor 125.

Because the point IDs are binded to the instantiated objects, the graphics processor 125 causes the data values received (initially or after a change) to be reflected or incorporated into the instantiated graphic object template. When a change of a data value for a point ID occurs, the building management data server 135 provides the changed data value, as a result of the subscription to that point ID, to the graphic object via the graphics processor 125. (Step 520). The graphics processor 125 then causes the presentation component 115 to re-render the display based on the received data value. (Step 525).

In further detail of the rendering of the graphics, and particularly of the instantiated graphic object templates, the graphics engine 110 and processor 125 creates objects that represent the drawing primitives (i.e. primitives 440 of FIG. 4) which have been grouped together as a graphics object template so that they operate as a single unit. Once these objects are instantiated, they are rendered by the presentation component 115, e.g. WPF Milcore, As a consequence, the graphics engine 110 does not need to process any code to handle repaint requests. All this is handled by the presentation format component, which is preferably a runtime component provided by the operating system development environment, such as .NET.

As discussed above, one of the advantages of at least one embodiment of the invention is the definitions of graphic object templates in a manner that allows granular adjustments without rewriting program code, and without intimate knowledge of the program code.

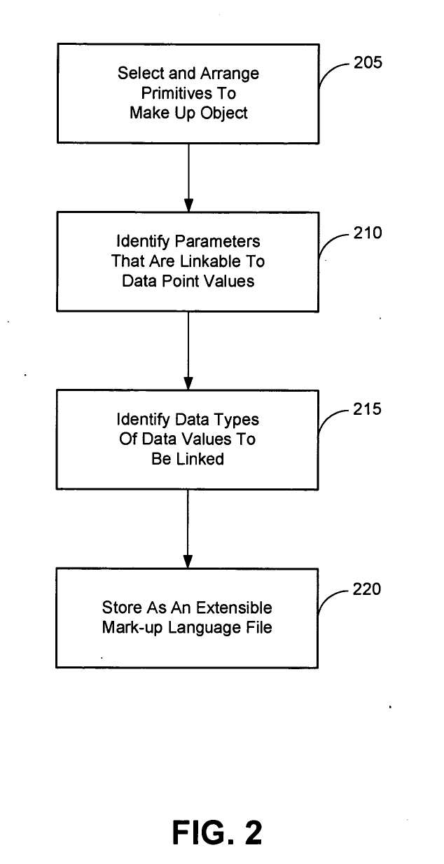

FIG. 2 shows an exemplary method employed in a software component to allow the definition of new graphic object templates for template the library storage 150. The software component of FIG. 2 may suitably be executed by any computer that can access the library 150, either by server or directly. For example, the steps of FIG. 2 may be carried out by the processing circuit of the client computer arrangement 102 of FIG. 1, and specifically by the graphics engine 110.

In step 205, the software component receives user selections or definitions of a number and arrangement of primitive graphic elements that make up the new object template. The primitive elements may suitably be selected from an available group that includes lines, rectangles, ellipses, polygons, shapes, text, images, buttons, symbolic state definitions, sliders or groups of the foregoing. Each primitive has parameters that describe it. A line has length, rotation angle (from horizontal), and color, for example. A rectangle has a length, height, rotation angle, color, and fill color, for example. Text has the actual text content. All of the primitive elements also have position information that identifies their relative position with respect to the other primitive elements.

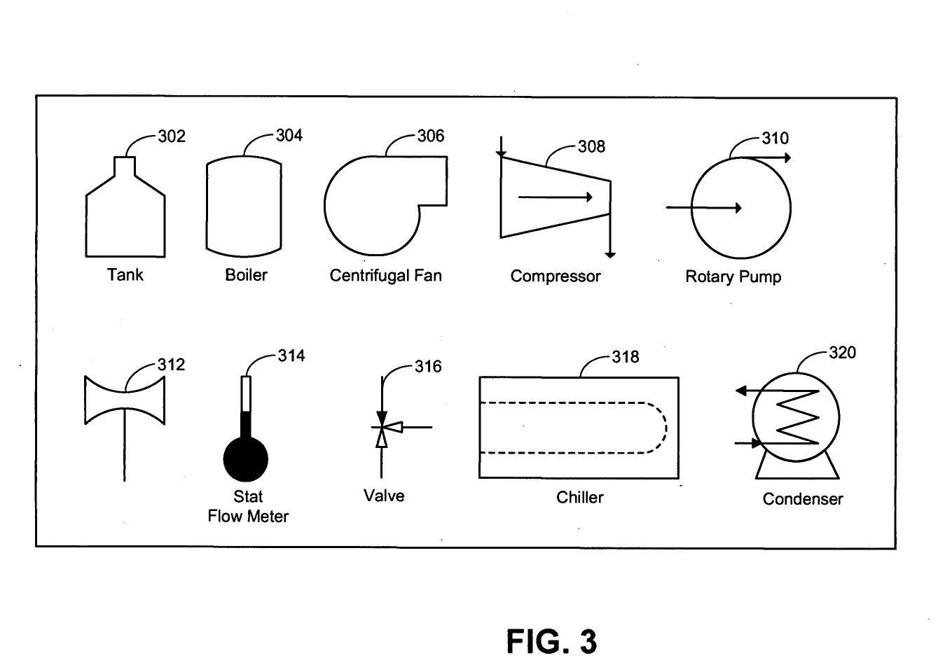

The resulting combination of primitives allows for more complex shapes to be provided in template form. For example, FIG. 3 shows examples of graphic primitives that have been combined to create rudimentary graphic object templates for a tank, boiler, centrifugal fan, compressor, rotary pump, flow meter, stat, valve, chiller and condenser.

In step 210, the software component receives identification of parameters of all primitives of the graphic object template that are linkable (i.e. bindable) to a data point. For example, an object template for a thermometer gauge may include a primitive in the shape of a rectangle that has a length that is linked to/defined by a data point for a temperature value. Thus, while the rectangle primitive may have a defined width parameter of 40 pixels, it may have a length that is variable, based on the value of a linked data point. In the object definition of step 210, however, an actual data point is not linked to the graphic object template. Instead, only the parameter that is to be linked to a data point is identified. A graphic object template may have multiple parameters of primitive elements that are linkable to/definable by data points.

The kinds of properties/parameters that may be binded to a data point property can be numerous. Such properties can include length, width, color tint, color depth, shading, blink speed, and even transparency. With regard to transparency, the graphic objects of a graphic page preferably support transparency properties to enable graphic objects to overlay one another, among other things.

In step 215, the software component identifies the data type of the data point or data points that are linkable to the parameters identified in step 210. The data type could be a “zone temperature value”, “fan speed value”, or “controller name”, for example. The data type may be another type of property of a data point, such as its alarm status. As is known in the art, building control system data points (e.g. a temperature of a zone) can be in an alarm state if they do not fall within alarm thresholds. In accordance with some embodiments of the invention, a parameter/property of a primitive element can be linked (i.e. binded) to an alarm state of a data point.

In step 220, the software component stores the information developed in steps 205 to 215 in an extensible mark-up language file. For example, the file may be XMAL string, which is suitable for use with the NET environment that employs the WPF and Milcore. The XMAL string may suitably be stored in a library, such as that of the library storage 150 of FIG. 1.

Table I below shows an exemplary graphic object template according to the present invention.

TABLE I

```
<Graphic GraphicType=“Graphic” BackColor=“#FFFFFFFF” GraphicWidth=“970”
GraphicHeight=“665” Version=“1.0.0.35” CreationDate=“2009-07-16T13:58:21.4888765-
05:00” LogicalScaleFactor=“1” GridStrokeColor=“#FF808080” Width=“970”
Height=“665” xmlns=“clr
namespace:Siemens.Gms.Graphics.Processor;assembly=Siemens.Gms.GraphicsProcessor”
xmlns:av=“http://schemas.microsoft.com/winfx/2006/xaml/presentation” xmlns:sggt=“clr-
namespace:Siemens.Gms.Graphics.Types;assembly=Siemens.Gms.GraphicsTypes”
xmlns:x=“http://schemas.microsoft.com/winfx/2006/xaml”>
  <Graphic.Depths>
    <Depths>
      <Depth DepthName=“Depth1” IsActive=“True” DisplaySize=“970”
    SymbolScaleFactor=“1” ActiveLayerInDepth=“Layer 1” />
    </Depths>
† </Graphic.Depths>
  <Graphic.Guidelines>
    <GmsCanvas Width=“980” Height=“701.74” />
  </Graphic.Guidelines>
    <GmsLayer IsActive=“True” Use=“True” Depths=“Depth1” Width=“970”
  Height=“665” Visible=“True” IsLocked=“False” Description=“Layer 1”>
    <GmsRectangle RadiusX=“15” RadiusY=“15” Width=“208” Height=“64”
  X=“48” Y=“64” StrokeColor=“#FF000000” FillColor=“#FFFF0000”>
      <GmsRectangle.Evaluations>
        <Evaluation PropertyName=“FillColor”
      Type=“sggt:CompoundBrush” EvaluationType=“Simple”
      x:Key=“FillColor”>
          <Evaluation.Expressions>
            <Expression Value=“{ }{*}.Present_Value” />
          </Evaluation.Expressions>
        </Evaluation>
† </GmsRectangle.Evaluations>
† </GmsRectangle>
† </GmsLayer>
† </Graphic>
```

The above definition illustrates how the properties of rectangle can be expressed in an extensible markup language, and readily modified or manipulated. The above example further illustrates how a property, the fill color, can be made dependent on a value of a data point.

Accordingly, steps 205 to 220 result in the addition of a new object template. The selection and connection of the primitives may be accomplished using drop and drag techniques, known in the art. The text of the resulting XMAL file may also be edited using text editors. The editing can change all or nearly all of the parameters simply by changing the values corresponding to the parameters, which is plainly apparent from the XMAL format.

It will be respectfully submitted that the above described embodiments are merely exemplary, and that those of ordinary skill in the art may readily devise their own implementations and modifications that incorporate that principles of the present invention and fall within the spirit and scope thereof.

I claim:

1. A method of displaying a value in a building control system, comprising:
a) retrieving a graphic object template defined as a markup language string, the graphic object template including a plurality of primitive elements, each of the plurality of primitive elements defined as a portion of the markup language string, at least one of the primitive elements having a parameter configurable to be dependent upon the value of the data point;
b) creating an instance of a graphic object template by binding a data point to the graphic object template;
c) obtaining a change of value for the data point;
d) updating the display to change the appearance of the first graphic primitive element based on the evaluation.

2. The method of claim 1, wherein step b) further comprises obtaining a sensed value from a sensor in a building, and generating the change of value for the data point responsive to the sensed value.

3. The method of claim 1, wherein step b) further comprises obtaining a state value of a building control element, and generating the change of value for the data point responsive to the state value.

4. The method of claim 1, further comprising generating the graphic object template by:
selecting each of the plurality of primitive elements for inclusion in the graphic object template;
identifying at least a first parameter of a first primitive element to be binded to a data point property.

5. The method of claim 4, wherein generating the graphic object template further comprises storing the graphic object template as an extensible mark-up language text format.

6. The method of claim 4, wherein the first parameter defines one of the group consisting of a length, width, rotational angle, color tint, color depth, and shading of a graphic element.

7. The method of claim 6, wherein the data point property is a sensed value from a sensor in a building.

8. The method of claim 6, wherein the data point property is a state value of a building control element.

9. The method of claim 1 wherein step a) further comprises transferring the markup language string from a server computer to a client computer over a network, and wherein step b) further comprises creating the instance of the graphic object template at the client computer.

10. The method of claim 6, wherein the created instance comprises an object that is configured to automatically receive changes in the value of the data point.
